(19) United States
(12) Patent Application Publication
(10) Pub. No.: US 2020/0398370 A1
(43) Pub. Date: Dec. 24, 2020

(54) LASER PROCESSING APPARATUS

(71) Applicant: DISCO CORPORATION, Tokyo (JP)

(72) Inventors: Keiji NOMARU, Tokyo (JP); Yuji HADANO, Tokyo (JP)

(21) Appl. No.: 16/904,060

(22) Filed: Jun. 17, 2020

(30) Foreign Application Priority Data
Jun. 21, 2019 (JP) 2019-115344

(51) Int. Cl. B23K 26/0622; B23K 26/06; B23K 26/122; B23K 26/08; B23K 37/04

(52) U.S. Cl. CPC B23K 26/0622; B23K 26/0665; B23K 26/122; B23K 2101/40; B23K 37/04; B23K 26/0643; B23K 26/0648; B23K 26/08

(57) ABSTRACT

A laser beam irradiation unit of a laser processing apparatus includes a first laser oscillator that emits a first laser beam with a short pulse width, a second laser oscillator that emits a second laser beam with a long pulse width, a polarizing beam splitter that combines the first laser beam and the second laser beam, and a liquid layer forming instrument that forms a layer of a liquid on the upper surface of a workpiece. The same place on the workpiece is irradiated with the first laser beam and the second laser beam while a chuck table and the laser beam irradiation unit are relatively moved, and plasma generated when irradiation with the first laser beam is performed through the layer of the liquid is grown by energy of the second laser beam to perform processing for the workpiece.

### BACKGROUND OF THE INVENTION

### Field of the Invention

The present invention relates to a laser processing apparatus that irradiates a workpiece held by a chuck table with a laser beam to perform processing.

### Description of the Related Art

A wafer on which plural devices such as an integrated circuit (IC) and a large-scale integration (LSI) are marked out by plural planned dividing lines that intersect and are formed on a front surface is divided into individual device chips by a laser processing apparatus, and the device chips obtained by the dividing are used for electronic equipment such as mobile phones, personal computers, and illuminating equipment.

Furthermore, as the laser processing apparatus, apparatuses of the following types exist: an apparatus of a type that performs irradiation with a laser beam with such a wavelength as to be absorbed by a workpiece and forms a groove that serves as the point of origin of dividing by ablation processing (for example, refer to Japanese Patent Laid-Open No. Hei 10-305420); an apparatus of a type that positions the focal point of a laser beam with such a wavelength as to be transmitted through a workpiece inside the workpiece and performs irradiation with the laser beam to form a modified layer that serves as the point of origin of dividing inside (for example, refer to Japanese Patent No. 3408805); and an apparatus of a type that positions the focal point of a laser beam with such a wavelength as to be transmitted through a workpiece inside the workpiece and performs irradiation to form plural shield tunnels composed of fine pores that serve as the point of origin of dividing and an amorphous part that surrounds the fine pores (for example, refer to Japanese Patent Laid-Open No. 2014-221483). The laser processing apparatus is selected based on the kind of workpiece, the processing accuracy, and so forth.

Moreover, in the type that performs ablation processing for a workpiece, possibly debris is scattered from the part irradiated with the laser beam and adheres to the devices formed on the front surface of the workpiece to lower the quality of the devices. Thus, a technique has been proposed in which, before execution of laser processing, the front surface of a wafer is coated with a liquid resin to prevent adhesion of debris (for example, refer to Japanese Patent Laid-Open No. 2004-188475).

### SUMMARY OF THE INVENTION

In the case of coating a workpiece with the liquid resin before executing laser processing for the workpiece as described above, there are problems that the liquid resin after the laser processing is discarded without being reused and therefore this technique is uneconomic, and that applying step and removal step of the liquid resin are necessary and therefore the productivity is low.

Furthermore, studies are being made also on a technique in which a workpiece is irradiated with a laser beam in a state in which a wafer is immersed in water to cause debris to float on the water and prevent the debris from adhering to the front surface of the wafer. However, a problem is also pointed out that the laser beams is scattered by bubbles and cavitation generated in the water and desired processing cannot be performed.

Thus, an object of the present invention is to provide a laser processing apparatus that prevents scattering of debris without deteriorating the productivity and can perform proper processing without scattering a laser beam.

In accordance with an aspect of the present invention, there is provided a laser processing apparatus including a chuck table that holds a plate-shaped workpiece, a laser beam irradiation unit that irradiates the workpiece held by the chuck table with a laser beam to perform processing, and a movement unit that moves the chuck table and the laser beam irradiation unit relatively. The laser beam irradiation unit includes a laser oscillator that emits the laser beam, a light condenser that condenses the laser beam emitted from the laser oscillator and irradiates the workpiece held by the chuck table with the laser beam, and a liquid layer forming instrument that is disposed at a lower end of the light condenser and forms a layer of a liquid on an upper surface of the workpiece. The laser oscillator includes a first laser oscillator that emits a first laser beam with a short pulse width and a second laser oscillator that emits a second laser beam with a long pulse width. A same place on the workpiece is irradiated with the first laser beam and the second laser beam while the chuck table and the laser beam irradiation unit are relatively moved by the movement unit, and plasma generated when irradiation with the first laser beam is performed through the layer of the liquid is grown by energy of the second laser beam to perform processing for the workpiece.

Preferably, the liquid layer forming instrument includes a casing having a bottom wall that forms a gap with the upper surface of the workpiece, a liquid supply part that is formed on a sidewall of the casing and fills the gap with the liquid through an ejection port formed in the bottom wall and causes the liquid to flow down, and a transparent part that is adjacent to the ejection port and is formed in the bottom wall and permits passing of the laser beam. Furthermore, the workpiece is irradiated with the laser beam through the transparent part and the layer of the liquid that fills the gap.

Preferably, the ejection port is formed of a slit that extends in a processing feed direction. Preferably, the laser beam irradiation unit further includes scattering means that scatters the laser beam in a processing feed direction.

According to the present invention, the first laser beam emitted from the first laser oscillator is in the state of being confined by the layer of the liquid and expansion thereof is suppressed. In addition, the first laser beam generates first plasma in the state in which the influence of heat is alleviated. This first plasma effectively induces the second laser beam emitted from the second laser oscillator and grows, which makes it possible to favorably process the workpiece.

Moreover, adhesion of debris is prevented without coating the front surface of the workpiece with a liquid resin and the cost can be reduced corresponding to the liquid resin. In addition, labor of coating the front surface of the workpiece with the liquid resin and removing the liquid resin can be omitted and the productivity improves. Furthermore, the layer of the liquid is formed between the lower end of the light condenser and the upper surface of the workpiece and is caused to flow down. Due to this, even when air bubbles are generated over the workpiece, these air bubbles can immediately be discharged from the processing region and the processing by the laser beam is not precluded.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus according to an embodiment of the present invention;

FIG. 2 is an exploded perspective view depicting the laser processing apparatus that is depicted in FIG. 1 and is partly disassembled;

FIG. 3A is a perspective view of a liquid layer forming instrument mounted in the laser processing apparatus depicted in FIG. 1;

FIG. 3B is an exploded perspective view depicting the liquid layer forming instrument disassembled;

FIG. 4 is a block diagram for explaining an optical system of a laser beam irradiation unit mounted in the laser processing apparatus depicted in FIG. 1;

FIG. 5 is a partially enlarged sectional view depicting an actuation state of the liquid layer forming instrument mounted in the laser processing apparatus depicted in FIG. 1 at a time of laser processing;

FIG. 6 is a waveform diagram depicting pulse widths of a first laser beam and a second laser beam;

FIG. 7A is a partially enlarged sectional view depicting plasma generated when processing is performed for a wafer by a laser beam; and

FIG. 7B is a partially enlarged sectional view depicting a processed groove obtained as a result of the laser processing.

### DETAILED DESCRIPTION OF THE PREFERRED EMBODIMENT

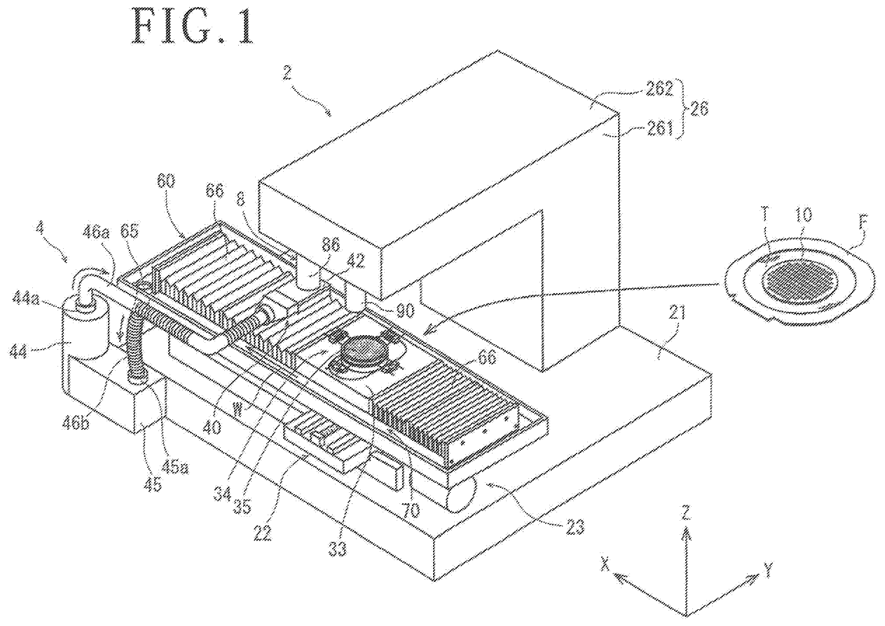

A laser processing apparatus of an embodiment of the present invention will be described in detail below with reference to the accompanying drawings. In FIG. 1, a perspective view of a laser processing apparatus 2 of the present embodiment is depicted. The laser processing apparatus 2 includes a liquid supply mechanism 4 that is disposed over a base 21 and supplies a liquid onto a workpiece (for example, wafer 10 made of silicon), a laser beam irradiation unit 8 that irradiates the plate-shaped workpiece with a laser beam, and a holding unit 22 that holds the workpiece. The laser processing apparatus 2 includes also a movement unit 23 that moves the laser beam irradiation unit 8 and the holding unit 22 relatively and a frame body 26 including a vertical wall part 261 disposed upright in a Z-direction depicted by an arrow Z on a lateral side of the movement unit 23 on the base 21 and a horizontal wall part 262 that extends in the horizontal direction from an upper end part of the vertical wall part 261.

Inside the horizontal wall part 262 of the frame body 26, an optical system (described in detail later) configuring the laser beam irradiation unit 8 that irradiates the wafer 10 held by the holding unit 22 with the laser beam is housed. On the lower surface side of the tip part of the horizontal wall part 262, a light condenser 86 that configures part of the laser beam irradiation unit 8 is disposed. In addition, an alignment unit 90 is disposed at a position adjacent to the light condenser 86 in a direction depicted by an arrow X in the diagram.

The alignment unit 90 is used for imaging the wafer 10 held by a chuck table 34 that configures the holding unit 22 and detecting a region for which laser processing should be performed and executing position adjustment between the light condenser 86 and a processing position of the wafer 10. The alignment unit 90 is equipped with an imaging element (charge-coupled device (CCD)) that uses a visible beam to image a front surface of the wafer 10. However, depending on the material forming the wafer 10, it is preferable for the alignment unit 90 to include infrared irradiation means that performs irradiation with infrared, an optical system that captures the infrared with which irradiation is carried out by the infrared irradiation means, and an imaging element (infrared CCD) that outputs an electrical signal corresponding to the infrared captured by the optical system.

As depicted in FIG. 1, for example, the wafer 10 is supported by a ring-shaped frame F with the intermediary of an adhesion tape T and is placed on a suction adhesion chuck 35 forming an upper surface of the chuck table 34 to be sucked and held. The above-described laser processing apparatus 2 is wholly covered by a housing or the like omitted for convenience of description and is configured in such a manner that fine particles, dust, and so forth do not enter the inside.

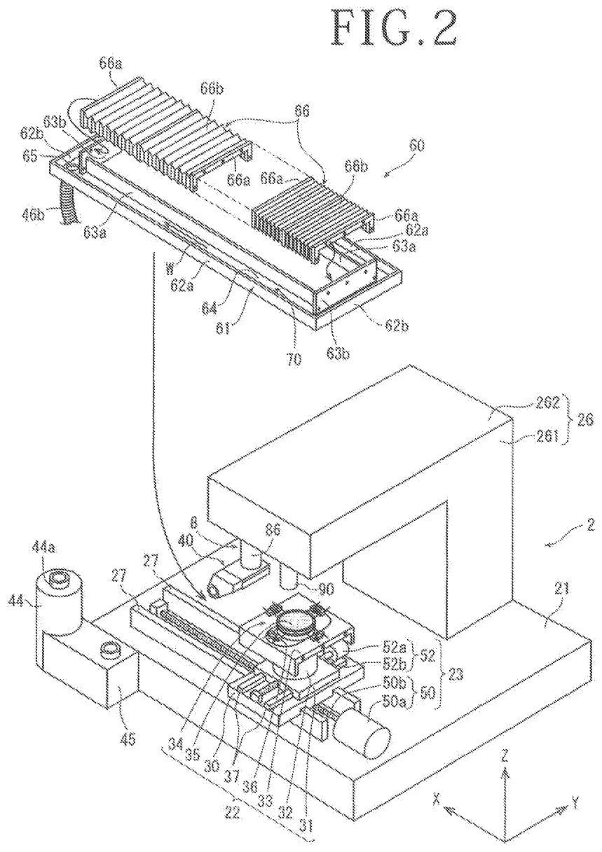

The laser processing apparatus 2 according to the present embodiment will be described in detail with reference to FIG. 2 in addition to FIG. 1. FIG. 2 is a perspective view depicting a state in which, in the laser processing apparatus 2 described in FIG. 1, a liquid recovery pool 60 that configures part of the liquid supply mechanism 4 has been removed from the laser processing apparatus 2 and been partly disassembled.

As depicted in FIG. 2, the holding unit 22 includes a rectangular X-direction movable plate 30 mounted on the base 21 movably in the X-direction depicted by the arrow X, a rectangular Y-direction movable plate 31 mounted on the X-direction movable plate 30 movably in a Y-direction that is depicted by an arrow Y and is orthogonal to the X-direction, a circular cylindrical support column 32 fixed to an upper surface of the Y-direction movable plate 31, and a rectangular cover plate 33 fixed to an upper end of the support column 32. The chuck table 34 that passes through a long hole formed in the cover plate 33 and extends upward is disposed over the cover plate 33. The chuck table 34 is configured to hold a circular workpiece and be rotatable by rotational drive means that is not depicted in the diagram. On the upper surface of the chuck table 34, the circular suction adhesion chuck 35 that is formed of a porous material having air permeability and extends substantially horizontally is disposed. The suction adhesion chuck 35 is connected to suction means that is not depicted in the diagram by a flow path that passes through the support column 32 and four clamps 36 are disposed around the suction adhesion chuck 35 at intervals. The clamps 36 grip the frame F that holds the wafer 10 when the wafer 10 is fixed to the chuck table 34. The plane defined by the X-direction and the Y-direction substantially forms the horizontal plane.

The movement unit 23 includes an X-direction movement unit 50 and a Y-direction movement unit 52. The X-direction movement unit 50 converts rotational motion of a motor 50a to linear motion through a ball screw 50b and transmits the linear motion to the X-direction movable plate 30 to cause the X-direction movable plate 30 to advance and retreat in the X-direction along guide rails 27 on the base 21. The Y-direction movement unit 52 converts rotational motion of a motor 52a to linear motion through a ball screw 52b and transmits the linear motion to the Y-direction movable plate 31 to cause the Y-direction movable plate 31 to advance and retreat in the Y-direction along guide rails 37 on the X-direction movable plate 30. Although diagrammatic representation is omitted, position detecting means is disposed for each of the chuck table 34, the X-direction movement unit 50, and the Y-direction movement unit 52, and the position in the X-direction, the position in the Y-direction, and the rotational position in the circumferential direction regarding the chuck table 34 are accurately detected. Based on the detected positions, the X-direction movement unit 50, the Y-direction movement unit 52, and rotational drive means of the chuck table 34, which is not depicted in the diagram, are driven, so that the chuck table 34 can accurately be positioned at any position and angle. The above-described X-direction movement unit 50 is processing feed means that causes the holding unit 22 to move in a processing feed direction and the Y-direction movement unit 52 is indexing feed means that causes the holding unit 22 to move in an indexing feed direction.

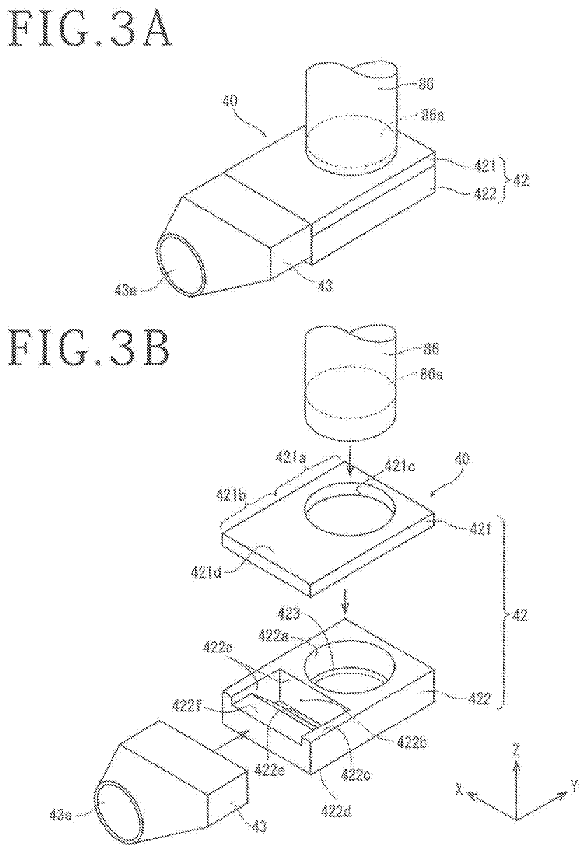

The liquid supply mechanism 4 will be described with reference to also FIG. 3 in addition to FIG. 1 and FIG. 2. As depicted in FIG. 1, the liquid supply mechanism 4 includes a liquid layer forming instrument 40, a liquid supply pump 44, a filter 45, the liquid recovery pool 60, a pipe 46a that connects the liquid layer forming instrument 40 and the liquid supply pump 44, and a pipe 46b that connects the liquid recovery pool 60 and the filter 45. It is preferable for the pipe 46a and the pipe 46b to be partly or wholly formed of a flexible hose.

As depicted in FIG. 3A, the liquid layer forming instrument 40 is disposed at a lower end part of the light condenser 86. An exploded view of the liquid layer forming instrument 40 is depicted in FIG. 3B. As is understood from FIG. 3B, the liquid layer forming instrument 40 includes a casing 42 and a liquid supply part 43. The casing 42 forms a substantially rectangular shape in plan view and includes a casing upper member 421 and a casing lower member 422.

The casing upper member 421 is divided into two regions 421a and 421b in the Y-direction depicted by the arrow Y in the diagram and a circular opening part 421c for insertion of the light condenser 86 is formed in a region 421a on the far side in the diagram. In a region 421b on the near side, a plate-shaped part 421d is formed. In the casing lower member 422, in a region opposed to the opening part 421c of the casing upper member 421, a circular cylindrical opening part 422a that has the same shape as the opening part 421c and corresponds with the opening part 421c in the disposing position in plan view is formed. A transparent part 423 with a circular plate shape is disposed at a bottom part of the opening part 422a and closes the bottom part of the opening part 422a. The transparent part 423 has such nature as to permit passing of a first laser beam LB1 and a second laser beam LB2 to be described later and is formed of a glass plate, for example.

In the casing lower member 422, a liquid flow path part 422b for ejecting a liquid from a bottom wall 422d of the casing 42 is formed in a region opposed to the plate-shaped part 421d of the casing upper member 421. The liquid flow path part 422b is a space formed by the plate-shaped part 421d of the casing upper member 421, sidewalls 422c, and the bottom wall 422d. A slit-shaped ejection port 422e that extends in the processing feed direction depicted by the arrow X is formed in the bottom wall 422d of the liquid flow path part 422b, and a liquid supply port 422f for supplying the liquid to the liquid flow path part 422b is formed in the sidewall on the side to which the liquid supply part 43 is coupled. The lower surface of the above-described transparent part 423 is formed to be flush with the slit-shaped ejection port 422e extending in the processing feed direction and the transparent part 423 forms part of the bottom wall 422d of the casing lower member 422 (see also FIG. 5).

The liquid supply part 43 includes a supply port 43a to which a liquid W is supplied, a discharge port (not depicted) formed at a position opposed to the liquid supply port 422f formed in the casing 42, and a communication path (not depict) that makes the supply port 43a and the discharge port communicate with each other. The liquid supply part 43 is assembled to the sidewall in which the liquid supply port 422f of the casing 42 is opened from the Y-direction and thereby the liquid layer forming instrument 40 is formed.

The liquid layer forming instrument 40 has the above-described configuration and the liquid W delivered from the liquid supply pump 44 passes through the liquid supply part 43 and is supplied to the liquid supply port 422f of the casing 42. Then, the liquid W flows in the liquid flow path part 422b of the casing 42 and is ejected from the ejection port 422e formed in the bottom wall 422d. For the liquid layer forming instrument 40, as depicted in FIG. 1, the liquid supply part 43 and the casing 42 are attached to the lower end part of the light condenser 86 in such a manner as to line up in the Y-direction. Due to this, the ejection port 422e formed in the bottom wall 422d of the casing 42 is positioned to extend along the X-direction, which is the processing feed direction.

Referring back to FIG. 1 and FIG. 2, the liquid recovery pool 60 will be described. As depicted in FIG. 2, the liquid recovery pool 60 includes an outer frame body 61 and two waterproof covers 66. The outer frame body 61 includes outside walls 62a that extend in the X-direction depicted by the arrow X in the diagram, outside walls 62b that extend in the Y-direction depicted by the arrow Y in the diagram, inside walls 63a and 63b disposed inside the outside walls 62a and 62b in parallel at predetermined intervals, and a bottom wall 64 that links lower ends of the outside walls 62a and 62b and the inside walls 63a and 63b. A rectangular liquid recovery path 70 having a longitudinal direction along the X-direction and a short direction along the Y-direction is formed by the outside walls 62a and 62b, the inside walls 63a and 63b, and the bottom wall 64. An opening that vertically penetrates is formed inside the inside walls 63a and 63b configuring the liquid recovery path 70. A minute inclination is set in the X-direction and the Y-direction for the bottom wall 64 configuring the liquid recovery path 70 and a liquid discharge hole 65 is disposed at a corner part that is the lowest position in the liquid recovery path 70 (corner part on the left side in the diagram). The pipe 46b is connected to the liquid discharge hole 65 and the liquid discharge hole 65 is connected to the filter 45 through the pipe 46b. It is preferable for the outer frame body 61 to be wholly formed of a plate material made of stainless steel resistant to corrosion and rust.

The two waterproof covers 66 each include fixing metal fittings 66a with a gate shape and an accordion-shaped cover member 66b that is made of a resin and has both ends to which the fixing metal fittings 66a are made to adhere. The fixing metal fittings 66a are formed with such dimensions as to be capable of straddling the two inside walls 63a disposed opposed to each other in the Y-direction in the outer frame body 61. One of the fixing metal fittings 66a of each of the two waterproof covers 66 is fixed to a respective one of the inside walls 63b disposed opposed to each other in the X-direction in the outer frame body 61. The liquid recovery pool 60 configured as above is fixed over the base 21 of the laser processing apparatus 2 by a fixing tool that is not depicted in the diagram. The cover plate 33 of the holding unit 22 is attached in such a manner as to be sandwiched by the fixing metal fittings 66a of the two waterproof covers 66.

The end surfaces of the cover plate 33 in the X-direction form the same gate shape as the fixing metal fittings 66a and have such dimensions as to straddle the inside walls 63a of the outer frame body 61 in the Y-direction similarly to the fixing metal fittings 66a. Therefore, the cover plate 33 is attached to the waterproof covers 66 after the outer frame body 61 of the liquid recovery pool 60 is set over the base 21. According to the above-described configuration, when the cover plate 33 is moved in the X-direction by the X-direction movement unit 50, the cover plate 33 moves along the inside walls 63a of the liquid recovery pool 60. The attaching method of the waterproof covers 66 and the cover plate 33 is not limited to the above-described procedure. For example, the cover plate 33 may be attached in advance before the two waterproof covers 66 are attached to the inside walls 63b of the outer frame body 61, and the waterproof covers 66 may be attached, together with the cover plate 33, to the outer frame body 61 attached to the base 21 in advance.

Referring back to FIG. 1, because the liquid supply mechanism 4 has the above-described configuration, the liquid W delivered from a delivery port 44a of the liquid supply pump 44 is supplied to the liquid layer forming instrument 40 via the pipe 46a. The liquid W supplied to the liquid layer forming instrument 40 is ejected downward from the ejection port 422e formed in the bottom wall 422d of the casing 42 of the liquid layer forming instrument 40. The liquid W ejected from the liquid layer forming instrument 40 flows on the cover plate 33 or the waterproof cover 66 and flows down to the liquid recovery pool 60. The liquid W that has flown down to the liquid recovery pool 60 flows in the liquid recovery path 70 and is collected to the liquid discharge hole 65 made at the lowest position in the liquid recovery path 70. The liquid W collected to the liquid discharge hole 65 is led to the filter 45 via the pipe 46b and laser processing waste (debris), dust, dirt, and so forth are removed in the filter 45. Then, the liquid W is returned to the liquid supply pump 44. In this manner, the liquid W delivered by the liquid supply pump 44 is circulated in the liquid supply mechanism 4.

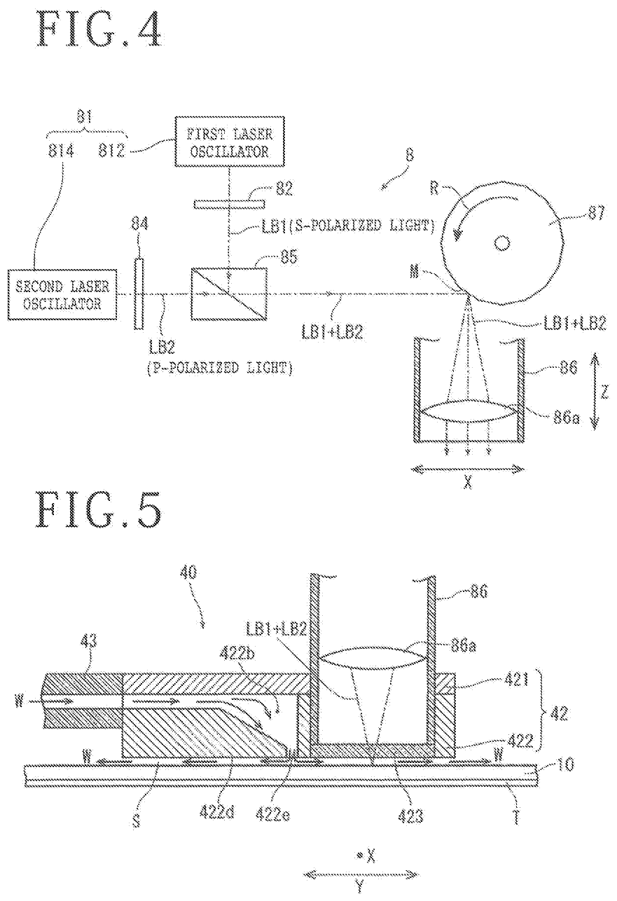

FIG. 4 is a block diagram depicting an outline of the optical system of the laser beam irradiation unit 8. As depicted in FIG. 4, the laser beam irradiation unit 8 includes a laser oscillator 81 including a first laser oscillator 812 that emits the first laser beam LB1 that is a pulsed laser beam and has a short pulse width and a second laser oscillator 814 that emits the second laser beam LB2 that is a pulsed laser beam and has a long pulse width. The laser beam irradiation unit 8 includes also a half-wave plate 82 that gives a phase difference corresponding to the half wavelength to the incident first laser beam LB1 and rotates the polarization plane of linear polarization, a half-wave plate 84 that gives a phase difference corresponding to the half wavelength to the incident second laser beam LB2 and rotates the polarization plane of linear polarization, and a polarizing beam splitter 85. The polarizing beam splitter 85 reflects S-polarized light of the first laser beam LB1 that has passed through the half-wave plate 82 and allows passing of P-polarized light of the second laser beam LB2 that has passed through the half-wave plate 84 therethrough. The polarizing beam splitter 85 combines the reflected first laser beam LB1 (S-polarized light) and the second laser beam LB2 (P-polarized light) allowed to pass therethrough in order to irradiate the same place on the wafer 10 and outputs the resulting laser beam as a laser beam LB1+LB2. The laser beam irradiation unit 8 includes also a polygon mirror 87 as scattering means that scatters the irradiation direction of the laser beam LB1+LB2 output from the polarizing beam splitter 85 and the light condenser 86 that condenses the laser beam LB1+LB2 and irradiates the wafer 10 held by the holding unit 22 with the laser beam LB1+LB2. The first laser oscillator 812 and the second laser oscillator 814 oscillate a laser with such a wavelength as to be absorbed by a workpiece, for example. Although diagrammatic representation is omitted, an attenuator that changes the output power of each laser beam, a reflective mirror that changes the optical path of each laser beam, and so forth may be included in the optical system of the laser beam irradiation unit 8 as appropriate.

The polygon mirror 87 disposed on an upstream side of the light condenser 86 on the optical path has a motor that rotates the polygon mirror 87 at high speed in a direction depicted by an arrow R and is not depicted in the diagram. Inside the light condenser 86, a condensing lens (fθ lens) 86a that condenses the laser beam LB1+LB2 and irradiates the wafer 10 with the laser beam LB1+LB2 is disposed. As depicted in FIG. 4, in the polygon mirror 87, plural mirrors M are disposed in a concentric manner with respect to the rotation axis of the polygon mirror 87. The fθ lens 86a is located below the above-described polygon mirror 87 and condenses the laser beam LB1+LB2 reflected by the polygon mirror 87 to irradiate the wafer 10 on the chuck table 34 with the laser beam LB1+LB2. Due to the rotation of the polygon mirror 87, the angle of the laser beam LB1+LB2 reflected by the mirrors M continuously changes in a predetermined range and the laser beam LB1+LB2 is scattered in a predetermined range in the processing feed direction (X-direction) on the wafer 10. As a result, a predetermined region on the planned dividing line is repeatedly irradiated with the laser beam LB1+LB2.

Moreover, the laser beam irradiation unit 8 includes focal point position adjusting means that is not depicted in the diagram. Diagrammatic representation of the specific configuration of the focal point position adjusting means is omitted. For example, the focal point position adjusting means may have a configuration having a ball screw that has a nut part fixed to the light condenser 86 and extends in the Z-direction depicted by the arrow Z and a motor coupled to a single end part of this ball screw. Based on such a configuration, rotational motion of the motor is converted to linear motion and the light condenser 86 is moved along guide rails (not depicted) disposed along the Z-direction. Thereby, the position in the Z-direction regarding the focal point of the laser beam LB focused by the light condenser 86 is adjusted.

The laser processing apparatus 2 of the present invention has the configuration described above in general. Operation thereof will be described below. For execution of laser processing by the laser processing apparatus 2 of the present embodiment, as depicted in FIG. 1, a plate-shaped workpiece supported by the ring-shaped frame F with the intermediary of the adhesion tape T, for example, the wafer 10 composed silicon (Si) on which devices are formed on the front surface, is prepared. After the wafer 10 has been prepared, the wafer 10 is placed on the suction adhesion chuck 35 of the chuck table 34 configuring the holding unit 22, with the front surface on which the devices are formed oriented upward, and the suction means that is not depicted in the diagram is actuated. In addition, the wafer 10 is fixed by the clamps 36 or the like.

After the wafer 10 has been held on the suction adhesion chuck 35, the chuck table 34 is moved in the X-direction and the Y-direction as appropriate by the movement unit 23 and the wafer 10 on the chuck table 34 is positioned directly under the alignment unit 90. After the wafer 10 has been positioned directly under the alignment unit 90, the front surface of the wafer 10 is imaged by the alignment unit 90. Subsequently, based on an image of the wafer 10 imaged by the alignment unit 90, position adjustment between the position at which processing should be performed on the wafer 10 and the light condenser 86 is performed by a method such as pattern matching. The chuck table 34 is moved based on position information obtained by this position adjustment. Thereby, the light condenser 86 is positioned above the processing start position on the wafer 10. Subsequently, the light condenser 86 is moved in the Z-direction by the focal point position adjusting means that is not depicted in the diagram and the focal point is positioned to the surface height of a single end part in the planned dividing line that is the laser processing start position of the wafer 10 in consideration of the refractive index of a layer of the liquid W formed between the liquid layer forming instrument 40 and the wafer 10, and so forth.

After the position adjustment between the light condenser 86 and the wafer 10 has been performed, the liquid supply mechanism 4 is replenished with the necessary and sufficient liquid W and the liquid supply pump 44 is actuated. As the liquid W that circulates inside the liquid supply mechanism 4, purified water is used, for example.

In FIG. 5, a schematic sectional view obtained by cutting the liquid layer forming instrument 40 along the Y-direction is depicted. As is understood from FIG. 5, the liquid layer forming instrument 40 of the liquid supply mechanism 4 is disposed at the lower end part of the light condenser 86, and setting is made in such a manner that a gap S of approximately 0.5 to 2.0 mm, for example, is formed by the bottom wall 422d and the transparent part 423 of the casing 42 configuring the liquid layer forming instrument 40 and the front surface of the wafer 10 when the focal point is positioned at the surface height of the wafer 10.

Because the liquid supply mechanism 4 has the above-described configuration, the liquid W delivered from the delivery port 44a of the liquid supply pump 44 is supplied to the liquid layer forming instrument 40. The liquid W supplied to the liquid layer forming instrument 40 is ejected downward from the ejection port 422e formed in the bottom wall 422d of the casing 42 of the liquid layer forming instrument 40. As depicted in FIG. 5, the liquid W ejected from the ejection port 422e forms a layer of the liquid W while filling the gap S formed between the bottom wall 422d of the casing 42 and the wafer 10, particularly between the transparent part 423 and the wafer 10. Thereafter, the liquid W flows out to the outside of the chuck table 34 and flows in the liquid recovery path 70 of the liquid recovery pool 60 to be collected to the liquid discharge hole 65 made at the lowest position in the liquid recovery path 70. The liquid W collected to the liquid discharge hole 65 is led to the filter 45 via the pipe 46b and is purified in the filter 45 to be returned to the liquid supply pump 44 and circulate in the liquid supply mechanism 4.

Through the elapse of a predetermined time (approximately several minutes) after the start of actuation of the liquid supply mechanism 4, the gap S between the bottom wall 422d of the casing 42, particularly the transparent part 423, and the wafer 10 is filled with the liquid W. Thereby, the layer of the liquid W that does not contain bubbles and cavitation is formed, which makes a state in which the liquid W stably circulates in the liquid supply mechanism 4.

In the state in which the liquid W is stably circulating in the liquid supply mechanism 4, the X-direction movement unit 50 configuring the movement unit 23 is actuated while the laser beam irradiation unit 8 is actuated. Thereby, the holding unit 22 and the laser beam irradiation unit 8 are relatively moved at a predetermined movement speed in the processing feed direction (X-direction).

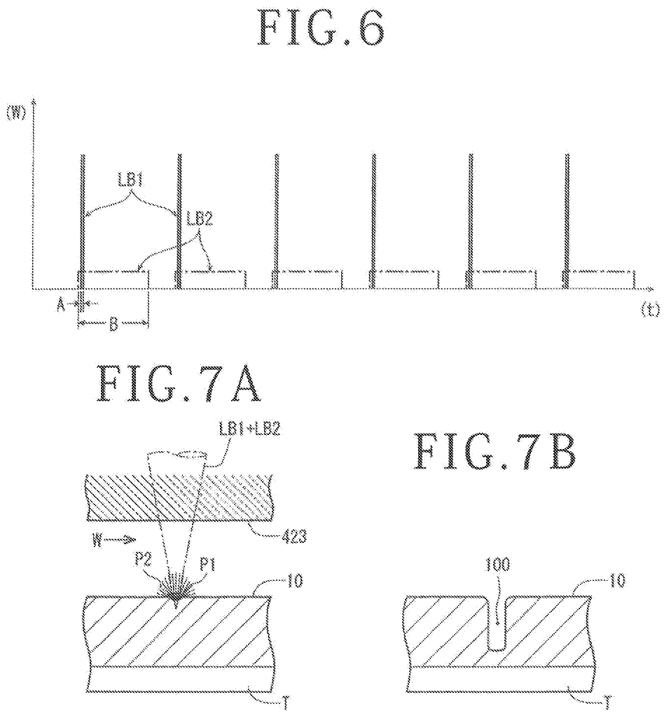

Here, laser processing implemented by the laser beam irradiation unit 8 of the present embodiment will be described in more detail with reference to FIG. 6 and FIGS. 7A and 7B in addition to FIG. 5. The laser beam LB1+LB2 emitted from the light condenser 86 passes through the transparent part 423 of the liquid layer forming instrument 40 and the layer of the liquid W and is applied to the processing-target position (planned dividing line) of the wafer 10 as depicted in FIG. 5. The laser beam LB1+LB2 is what is obtained by combining the first laser beam LB1 and the second laser beam LB2 as described above. As depicted in FIG. 6, the first laser beam LB1 is set with an extremely short pulse width A. In addition, the second laser beam LB2 is set with a long pulse width B with respect to the first laser beam LB1 and irradiation with the second laser beam LB2 is performed in synchronization with the first laser beam LB1.

In irradiation of the wafer 10 with the laser beam LB1+LB2, the wafer 10 is irradiated with the laser beam LB1+LB2 in a scattered manner in association with rotation of the polygon mirror 87 as described based on FIG. 4. Specifically, after the predetermined mirror M is irradiated with the laser beam LB1+LB2, the next mirror M located on the downstream side in the rotation direction R of the polygon mirror 87 is irradiated with the laser beam LB1+LB2. Thus, along the planned dividing line of the wafer 10, irradiation is repeatedly performed plural times while the laser beam LB1+LB2 is scattered. While the laser beam LB1+LB2 is oscillated from the laser oscillator 81 including the first laser oscillator 812 and the second laser oscillator 814 and the polygon mirror 87 rotates, such laser processing is repeated. The number of mirrors M configuring the polygon mirror 87, the rotation speed of the polygon mirror 87, and so forth are decided as appropriate according to the workpiece.

The laser processing in the above-described laser processing apparatus 2 can be performed under the following processing condition, for example.

### First Laser Oscillator

Wavelength of first laser beam: 355 nm, 532 nm, 1064 nm

Average output power: 10 to 30 W

Repetition frequency: 1 to 10 MHz

Pulse width: 50 fs to 50 ps

### Second Laser Oscillator

Wavelength of second laser beam: 355 nm, 532 nm, 1064 nm

Average output power: 30 W

Repetition frequency: 1 to 10 MHz

Pulse width: 50 ns

As is understood from FIG. 6 and FIG. 7A, irradiation with the second laser beam LB2 is performed at timing when the second laser beam LB2 is introduced into plasma P1 generated near the front surface of the wafer 10 due to irradiation of the processing position of the wafer 10 with the first laser beam LB1. In the present embodiment, as described based on FIG. 6, the first laser beam LB1 is set with an extremely short pulse width and the second laser beam LB2 is set with a long pulse width with respect to the first laser beam LB1. What is more, setting is made in such a manner that the peak intensity of the first laser beam LB1 is high and the peak intensity of the second laser beam LB2 is greatly low compared with the first laser beam LB1.

As described above, when the wafer 10 is irradiated with the laser beam LB1+LB2, as depicted in FIG. 7A, the first plasma P1 is generated over the front surface of the wafer 10 due to irradiation with the first laser beam LB1 with the high peak intensity and the short pulse width. Moreover, because irradiation with the second laser beam LB2 is performed in synchronization with the first laser beam LB1, the second laser beam LB2 is emitted toward this first plasma P1. Thereby, energy of the second laser beam LB2 is induced into the first plasma P1 and the first plasma P1 is grown to second plasma P2. Then, due to operation of the polygon mirror 87, irradiation with the laser beam LB1+LB2 is repeatedly performed along the planned dividing line and, as depicted in FIG. 7B, laser processing excellent in the isotropy is performed toward the lower side of the irradiation position and the wafer 10 is dug down with a circular shape, so that a processed groove 100 with a desired depth is formed along the planned dividing line.

It is envisaged that, when the laser processing is performed in the above-described state, air bubbles are generated in the liquid W existing at the position irradiated with the laser beam LB1+LB2 on the wafer 10. As a countermeasure against this, in the present embodiment, the liquid W is caused to always flow in the gap S formed over the wafer 10 at a predetermined flow rate as described based on FIG. 5. Due to this, air bubbles generated near the irradiation position of the laser beam LB1+LB2 are caused to immediately flow down from the gap S generated over the wafer 10 to the external and be removed by the liquid W. In particular, according to the present embodiment, the ejection port 422e formed in the bottom wall 422d of the casing 42 exists at a position adjacent to the transparent part 423 also disposed in the bottom wall 422d in the Y-direction and is formed with the slit shape that extends in the processing feed direction. Due to this configuration, the liquid W is supplied from the direction orthogonal to the X-direction, which is the direction in which the laser beam LB1+LB2 is scattered, and the air bubbles generated in the liquid W are immediately discharged. This can irradiate the wafer 10 with the laser beam LB1+LB2 with avoidance of the air bubbles generated due to this laser processing.

Moreover, the liquid W continuously flows down while filling the gap S over the wafer 10. Due to this, even when debris is discharged from the front surface of the wafer 10 into the liquid W, the debris is immediately discharged from over the wafer 10 similarly to the above-described air bubbles. As is understood from FIG. 1, the liquid W containing the above-described air bubbles and debris flows on the cover plate 33 and the waterproof covers 66 and is led to the liquid recovery path 70 of the liquid recovery pool 60. The liquid W led to the liquid recovery path 70 flows in the liquid recovery path 70 while discharging the air bubbles generated due to the laser processing to the external, and is discharged from the liquid discharge hole 65 formed at the lowest part of the liquid recovery path 70. The liquid W discharged from the liquid discharge hole 65 is led to the filter 45 via the pipe 46b and is supplied to the liquid supply pump 44 again. Due to the circulation of the liquid W in the liquid supply mechanism 4 in this manner, debris, dust, and so forth are captured by the filter 45 as appropriate and the liquid W is kept at a clean state.

After the above-described laser processing has been performed for the predetermined planned dividing line, the light condenser 86 is positioned to a single end part of the yet-to-be-processed planned dividing line adjacent to the planned dividing line for which the laser processing has been already performed in the Y-direction by actuating the movement unit 23, and laser processing similar to the above-described laser processing is performed. Then, after the laser processing has been performed for adjacent all planned dividing lines, the chuck table 34 is rotated by 90 degrees and thereby similar laser processing is performed also for yet-to-be-processed planned dividing lines orthogonal to the planned dividing lines in the predetermined direction for which the processing has been performed previously. In this manner, the laser processing is performed for all planned dividing lines on the wafer 10, so that the processed grooves 100 that serve as the point of origin of dividing can be formed.

In the present embodiment, as described above, the desired irradiation position is irradiated with the laser beam LB1+LB2 through the layer of the liquid W and processing is performed by the second plasma P2 grown from the first plasma P1. In the case of executing processing by a laser beam with a short pulse width like the first laser beam LB1, anisotropy exists in the processing direction. Therefore, when processing is performed by only the first laser beam LB1, the sectional shape of the processed part becomes a V-shape and the processing speed drastically lowers when the processing advances from the front surface in the depth direction. However, in the case of executing irradiation with the laser beam LB1+LB2 obtained by combining the first laser beam LB1 with the short pulse width and the second laser beam LB2 with the long pulse width as in the present embodiment, as described based on FIG. 7B, processing excellent in the isotropy is performed and the wafer 10 can be dug down with a circular shape toward the lower side of the irradiation position without lowering of the processing speed. Thus, the processed groove 100 with a desired depth can be formed along the planned dividing line at a favorable processing speed.

According to the present embodiment, adhesion of debris to the front surface of the wafer 10 can be prevented without coating the front surface of the wafer 10 with a liquid resin. Thus, the cost can be reduced corresponding to the liquid resin. Because labor of applying and removing the liquid resin can be omitted, the productivity improves.

Furthermore, the first laser beam LB1 is applied to the wafer 10 through the layer of the liquid W (gap S) formed by the liquid layer forming instrument 40 and generates the first plasma P1. At this time, the first plasma P1 is generated while being confined by the layer of the liquid W that flows down. Thus, excessive expansion of the first plasma P1 is suppressed. Moreover, the influence of heat is alleviated. Furthermore, the second laser beam LB2 is absorbed by the first plasma P1 generated by the first laser beam LB1 with the short pulse width and generates the second plasma in the layer of the liquid W that flows down to perform processing. Therefore, compared with the case of executing laser processing by only the second laser beam LB2, thermal influence given to the surroundings of the planned dividing line of the wafer 10 is limited and the flexural strength when the wafer 10 is divided into individual device chips improves. That is, by combining the first laser beam LB1 and the second laser beam LB2 and irradiating a workpiece with the laser beam LB1+LB2 as in the present embodiment, excellent laser processing is enabled compared with the case of executing irradiation with either the first laser beam LB1 or the second laser beam LB2 alone to perform laser processing.

According to the present invention, the configuration is not limited to the above-described embodiment and various modification examples are provided. For example, in the above-described embodiment, the description is made based on the premise that the second laser beam LB2 is a pulsed laser beam. However, the present invention is not limited thereto. It suffices that the second laser beam LB2 is a laser beam emitted with a longer width than the pulse width of the first laser beam LB1. Therefore, the second laser beam LB2 may be a continuous wave (CW). That is, a laser beam that is the continuous wave (CW) is also included in the “second laser beam with a long pulse width” in the present invention.

In the above-described embodiment, it is explained that the second laser beam LB2 is oscillated in synchronization with the first laser beam LB1 and, as depicted in FIG. 6, the second laser beam LB2 is oscillated in such a manner that irradiation with the second laser beam LB2 is performed simultaneously with the first laser beam LB1. However, the present invention is not limited thereto. For example, after irradiation with the first laser beam LB1 is performed, irradiation with the second laser beam LB2 may be performed before the first plasma P1 generated by the first laser beam LB1 disappears. If the second laser beam LB2 is oscillated before the first plasma P1 disappears even after irradiation with the first laser beam LB1 is performed as above, the same operation and effects as those described above can be achieved.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table that holds a plate-shaped workpiece;
a laser beam irradiation unit that irradiates the workpiece held by the chuck table with a laser beam to perform processing; and
a movement unit that moves the chuck table and the laser beam irradiation unit relatively, wherein
the laser beam irradiation unit includes a laser oscillator that emits the laser beam, a light condenser that condenses the laser beam emitted from the laser oscillator and irradiates the workpiece held by the chuck table with the laser beam, and a liquid layer forming instrument that is disposed at a lower end of the light condenser and forms a layer of a liquid on an upper surface of the workpiece,
the laser oscillator includes a first laser oscillator that emits a first laser beam with a short pulse width and a second laser oscillator that emits a second laser beam with a long pulse width, and
a same place on the workpiece is irradiated with the first laser beam and the second laser beam while the chuck table and the laser beam irradiation unit are relatively moved by the movement unit, and plasma generated when irradiation with the first laser beam is performed through the layer of the liquid is grown by energy of the second laser beam to perform processing for the workpiece.

2. The laser processing apparatus according to claim 1, wherein
the liquid layer forming instrument includes a casing having a bottom wall that forms a gap with the upper surface of the workpiece, a liquid supply part that is formed on a sidewall of the casing and fills the gap with the liquid through an ejection port formed in the bottom wall and causes the liquid to flow down, and a transparent part that is adjacent to the ejection port and is formed in the bottom wall and permits passing of the laser beam, and
the workpiece is irradiated with the laser beam through the transparent part and the layer of the liquid that fills the gap.

3. The laser processing apparatus according to claim 2, wherein
the ejection port is formed of a slit that extends in a processing feed direction.

4. The laser processing apparatus according to claim 1, wherein
the laser beam irradiation unit further includes scattering means that scatters the laser beam in a processing feed direction.
